(19) United States
(12) Patent Application Publication
(10) Pub. No.: US 2008/0068580 A1
(43) Pub. Date: Mar. 20, 2008

(54) SUBSTRATE-RETAINING UNIT

(75) Inventors: Eriko Mori, Saitama-shi (JP); Ken Katsuta, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/858,063

(22) Filed: Sep. 19, 2007

(30) Foreign Application Priority Data
Sep. 20, 2006 (JP) 2006-254287

(51) Int. Cl. G03B 27/58

(52) U.S. Cl. 355/72

(57) ABSTRACT

A wafer chuck includes a plurality of supporting pins protruding upward. The rigidity of the supporting pins in the horizontal direction is lower than that in the vertical direction in a central area of the wafer chuck. The supporting pins deform in response to a force for returning a central warped portion of a wafer from a warped state to an original state, thereby releasing part of or all the strain in the wafer.

### BACKGROUND OF THE INVENTION

1. Field of the Invention

The present invention relates to substrate-retaining units used for apparatuses for producing semiconductor elements, liquid-crystal display elements, and the like.

2. Description of the Related Art

In general, projection-type exposure apparatuses used for producing semiconductor elements, liquid-crystal display elements, and the like use substrate-retaining units that retain substrates to be processed while the flatness of the surfaces of the substrates is maintained by attracting and holding the substrates with vacuum such that the warpage of the substrates is corrected.

Japanese Patent Laid-Open Nos. 4-14239 (corresponding to U.S. Pat. No. 5,374,829), 10-233433 (corresponding to U.S. Pat. No. 5,923,408), 10-242255, 2000-311933 (corresponding to U.S. Pat. No. 6,307,620), 2001-60618, and 2004-259792 describe such substrate-retaining units. FIG. 8 is a cross-sectional view illustrating an example of a known substrate-retaining unit. The substrate-retaining unit shown in FIG. 8 includes a wafer chuck 2 having a wafer-supporting surface 1 on which a wafer W is placed. The wafer chuck 2 has a large number of protrusions 6 that support the wafer W on the wafer-supporting surface 1 of the wafer chuck 2, and has three through holes 3 that pass through the wafer chuck 2 from the wafer-supporting surface 1 (top surface) to the back surface. Cylindrical walls 4 with a small diameter are formed on the wafer-supporting surface 1 so as to define the peripheries of the through holes 3, and a cylindrical wall 5 with a large diameter is formed on the wafer-supporting surface 1 so as to surround the periphery of the wafer-supporting surface 1.

The substrate-retaining unit further includes lift pins 7 for transferring the wafer W and disposed inside the through holes 3, a lifting mechanism 8 for vertically moving the lift pins 7, and a supporting portion 9 for supporting the wafer chuck 2. In addition, the substrate-retaining unit includes a vacuum piping system 10 for attracting and holding the wafer W on the wafer-supporting surface 1 with vacuum by reducing the pressure (forming a negative pressure) in a space formed by the wafer W, the wafer-supporting surface 1, and the cylindrical walls 4 and 5 with respect to atmospheric pressure.

In this structure, the wafer W is transferred by a robot hand from an external conveying unit onto the waiting lift pins 7 protruding from the wafer-supporting surface 1. The robot hand is retracted after transferring the wafer W. Subsequently, the lifting mechanism 8 immediately lowers the lift pins 7 so as to transfer the wafer W onto the wafer-supporting surface 1. Before the wafer W is brought into contact with the wafer-supporting surface 1, vacuum suction is started using the vacuum piping system 10. The wafer W is attracted and fixed to the wafer-supporting surface 1 by the vacuum suction while being retained by the protrusions 6, thereby the flatness of the wafer W is corrected.

The wafer W is exposed to light passing through a pattern of a reticle (transfer) while the wafer W is retained by the substrate-retaining unit. After the exposure (transfer), the operations performed before the exposure are performed in the opposite order, and the wafer W is retrieved from the substrate-retaining unit by the robot hand.

In general, during attracting of the wafer W supported by the lift pins 7 to the substrate-retaining unit with vacuum, the suction using the vacuum piping system 10 is started prior to the lowering operation of the wafer W. At this moment, reduction of the pressure in a space under idle suction is started as the wafer W approaches the wafer-supporting surface 1. When the pressure drops sharply, a strain caused by the deformation of the wafer W generated immediately before the adhesion of the wafer W remains after the adhesion due to the frictional force generated between the back surface of the wafer W and the upper surfaces of the protrusions 6, resulting in warpage of the top surface of the wafer W.

### SUMMARY OF THE INVENTION

The present invention is directed to a substrate-retaining unit capable of releasing part of or all the strain remaining in a wafer after the adhesion of the wafer.

According to an aspect of the present invention, a substrate-retaining unit includes a plurality of protrusions, a substrate being adhered to the unit while the substrate is supported by the protrusions. The rigidity of the protrusions in a horizontal direction is lower than the rigidity in a vertical direction at least in a central area of the unit. For example, the protrusions arranged at least in the central area of the unit can be composed of silicon carbide, and can be cylindrical having a diameter d that is less than or equal to 0.35 times a height h. Moreover, the protrusions arranged at least in the central area of the unit can be composed of fiber laminate.

Further features of the present invention will become apparent from the following description of exemplary embodiments with reference to the attached drawings.

### BRIEF DESCRIPTION OF THE DRAWINGS

FIG. 1 illustrates the structure of a reduced projection exposure apparatus to which a wafer chuck according to a first exemplary embodiment of the present invention is incorporated.

FIG. 2 is a plan view of the wafer chuck shown in FIG. 1.

FIG. 3 is a cross-sectional view of the wafer chuck shown in FIG. 1.

FIG. 4 is an enlarged cross-sectional view of supporting pins shown in FIG. 3.

FIG. 5 is a plan view of a wafer chuck according to a second exemplary embodiment of the present invention.

FIG. 6 is a flow chart of producing a microscopic device.

FIG. 7 is a flow chart illustrating wafer processing.

FIG. 8 is a cross-sectional view illustrating a known substrate-retaining unit.

### DESCRIPTION OF THE EMBODIMENTS

### First Exemplary Embodiment

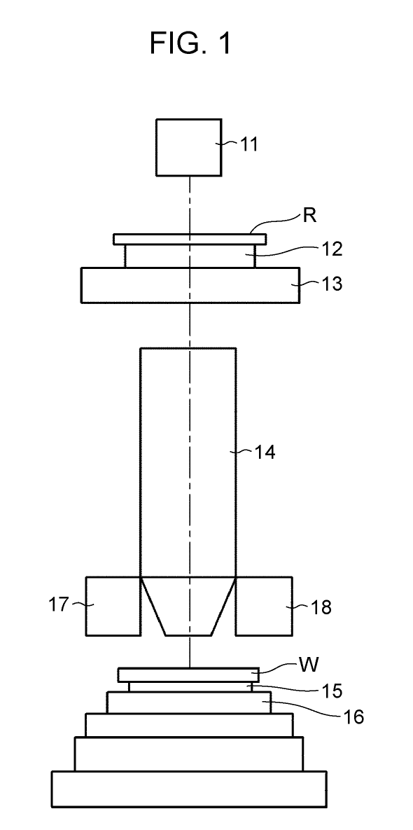

A first exemplary embodiment of the present invention will now be described in detail with reference to FIGS. 1 to 4.

FIG. 1 illustrates the structure of a reduced projection exposure apparatus to which a wafer chuck according to the first exemplary embodiment of the present invention is incorporated. FIG. 1 illustrates an illumination optical system 11, a reticle R, a reticle chuck 12, a reticle stage 13, a projection optical system 14, a silicon wafer W, a wafer chuck 15, and an XYθ stage 16 arranged from a side adjacent to a light source (not shown). In particular, the optical systems 11 and 14, the reticle R, and the wafer W are disposed on a path of exposure light emitted from the light source. An off-axis alignment scope 17 and a surface-position measuring unit 18 are disposed in the vicinity of the projection optical system 14.

During exposure, the reticle R serving as a negative plate is placed on the reticle stage 13 via the reticle chuck 12. The reticle R is irradiated with the exposure light emitted from the illumination optical system 11. The exposure light passing through the reticle R is reduced to, for example, one fifth by the projection optical system 14, and is incident on the silicon wafer W to be processed. The wafer chuck 15 retaining the wafer W is placed on the XYθ stage 16 that is movable on a horizontal plane.

Operations of the exposure apparatus are started when a command for starting exposure is issued while the wafer W is automatically or manually set in the exposure apparatus. First, a first wafer W is sent onto the wafer chuck 15 by a conveying system. Next, the magnification, the rotation, and the XY deviation of the wafer W are determined by detecting alignment marks on the wafer W using the off-axis alignment scope 17 such that the position of the wafer W is corrected. The XYθ stage 16 moves the wafer W such that the first-shot position on the wafer W placed on the XYθ stage 16 corresponds to the exposure position of the exposure apparatus.

Subsequently, the focus of the projection optical system 14 is adjusted on the wafer W on the basis of the measurement results of the surface-position measuring unit 18, and the wafer W is exposed to light for approximately 0.2 seconds during the first shot. The wafer W is then moved to the second-shot position by one step, and exposure is performed again. These operations are repeated until the last shot. In this manner, the exposure process of one wafer W is completed. The wafer W after the exposure process is transferred from the wafer chuck 15 to a robot hand (not shown), and returned to a known wafer carrier by the robot hand.

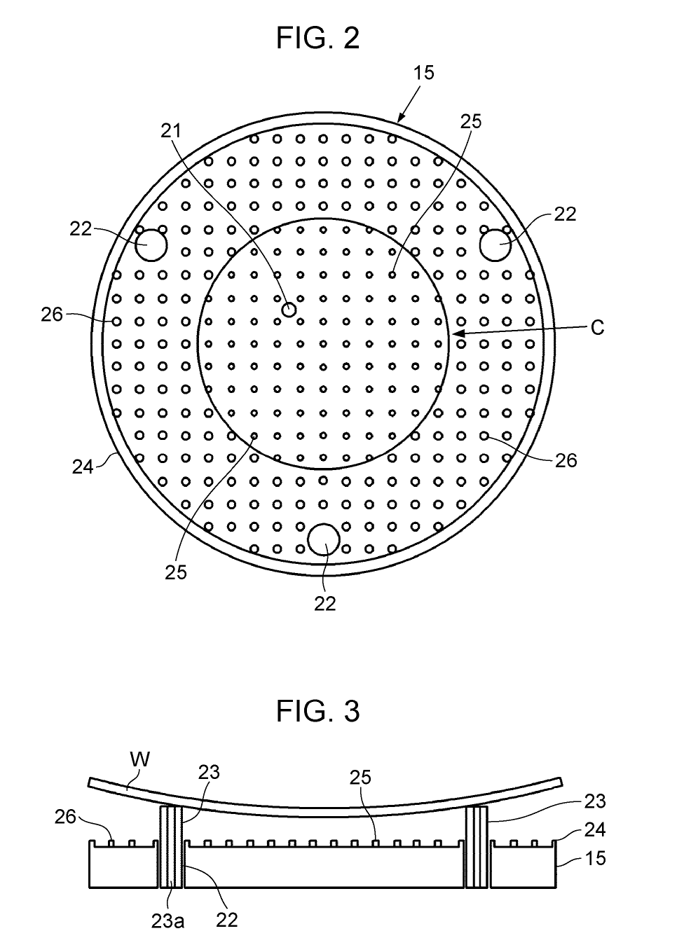

FIGS. 2 and 3 are a plan view and a cross-sectional view, respectively, of the wafer chuck 15 shown in FIG. 1. As shown in FIG. 2, the disk-shaped wafer chuck 15 has a suction hole 21 for attracting the wafer W serving as a substrate with vacuum in the vicinity of the center of the wafer chuck 15. A vacuum piping system as shown in FIG. 8 is used for the vacuum suction. The wafer chuck 15 further has three through holes 22 arranged equiangularly in a circumferential direction thereof. Lift pins 23, each having an exhaust hole 23a, pass through the corresponding through holes 22 so as to be vertically movable.

A cylindrical wall 24 is formed along the edge portion of the wafer chuck 15. A large number of supporting pins (protrusions) 25 integrated with the wafer chuck 15 protrude vertically upward in an area of a circle C (central area) inside the cylindrical wall 24. Similarly, a large number of supporting pins (protrusions) 26 integrated with the wafer chuck 15 protrude upward in an area between the circle C and the cylindrical wall 24 of the wafer chuck 15 (peripheral area). The supporting pins 25 and 26 are arranged at regular intervals of, for example, 2 mm in a grid pattern. The supporting pins 25 in the central area support the central portion of the wafer W, and the supporting pins 26 in the peripheral area support the peripheral portion of the wafer W. In the first exemplary embodiment, the wafer chuck 15 and the supporting pins 25 and 26 are composed of silicon carbide (SiC).

In the first exemplary embodiment, the rigidity of the supporting pins 25 disposed in the central area (first area) in the horizontal direction is lower than that in the vertical direction, and the rigidity of the supporting pins 26 disposed in the peripheral area (second area) in the horizontal direction is higher than that of the supporting pins 25 in the horizontal direction. Moreover, the radius of the central area (circle C) is approximately half the radius of the wafer chuck 15 in the first exemplary embodiment. However, the radius of the central area can be approximately one third of that of the wafer chuck 15. Furthermore, it is not necessary for the wafer chuck to be partitioned into two areas of the circular central area and the ring-shaped peripheral area in which the rigidities of the supporting pins in the horizontal direction differ from each other, and the supporting pins 25 whose rigidity in the horizontal direction is lower than that in the vertical direction can be arranged in the entire area of the wafer chuck.

Before adhesion of the wafer W, the lift pins 23 raised for transferring the wafer W support the wafer W above the supporting pins 25 and 26 of the wafer chuck 15, and hold the wafer W with vacuum via the exhaust holes 23a thereof. At this moment, the wafer W is warped downward by the weight of the wafer W as shown in FIG. 3.

The lift pins 23 are lowered from the state shown in FIG. 3 such that the wafer W approaches the wafer chuck 15. Evacuation via the suction hole 21 is started at the same time as the lowering operation such that the pressure inside a space surrounded by the back surface of the wafer W, the top surface (wafer-supporting surface) of the chuck, and the cylindrical wall 24 becomes negative. With this, the wafer W is successively held by the wafer chuck 15 from the central portion to the peripheral portion. Since the wafer W is pressed toward the wafer chuck 15 by the attraction force caused by the negative pressure while the wafer W is retained by the cylindrical wall 24 and is warped downward, a strain is generated in the central portion of the wafer W.

In order to release part of or all the strain generated in the central portion of the wafer by the deformation of the supporting pins in the horizontal direction, the ratio d/h of the width d to the height h of the supporting pins 25 arranged in the central area of the wafer chuck 15 is smaller than that of the supporting pins 26 arranged in the peripheral area in the first exemplary embodiment. When the rigidity of the supporting pins 25 in the horizontal direction is reduced as compared with that in the vertical direction such that the supporting pins 25 can be easily deformed in the horizontal direction, the supporting pins 25 deform in the horizontal direction in response to a force for returning the wafer W from the warped state to an original state, and the strain in the wafer W can be reduced.

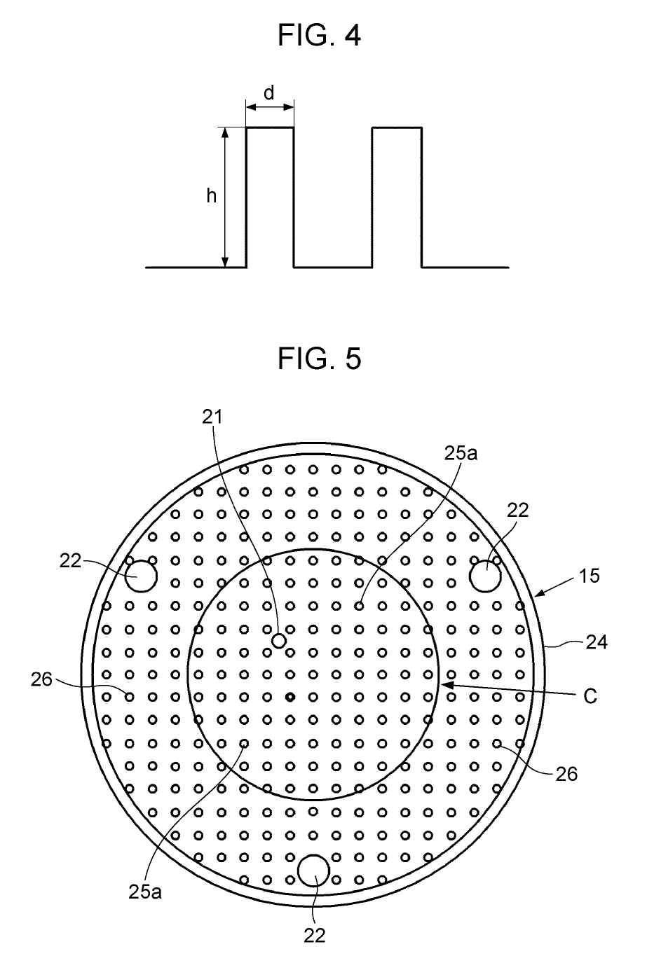

In the first exemplary embodiment, the shape of the supporting pins 25 is determined such that the deformation remaining in the wafer W does not exceed 2 nm. More specifically, the supporting pins 25 in the first exemplary embodiment are cylindrical, and the ratio d/h of the diameter d to the height h shown in FIG. 4 is set to 0.35 or less on the basis of the following expressions:

x≦2 nm (1)

x=Fh³/3Eh=32Fh³/3Eπd³ (2)

where x, E, and F denote a permissible value of the amount of deformation of the supporting pins 25 in the horizontal direction, Young's modulus of the material of the supporting pins 25, and a horizontal force applied to the supporting pins 25, respectively.

When the supporting pins 25 are composed of SiC and the Young's modulus E and the force F applied to the supporting pins 25 are 420 GPa and 10 N, respectively, the diameter d of the supporting pins 25 becomes less than or equal to 0.35 times the height h. The supporting pins 26 are also cylindrical, and the diameter d of the supporting pins 26 is larger than 0.35 times the height h, for example, 1.00.

### Second Exemplary Embodiment

FIG. 5 is a plan view of a wafer chuck 15 according to a second exemplary embodiment of the present invention. In FIG. 5, a large number of cylindrical supporting pins (protrusions) 25a arranged inside a circle C in a central area (first area) of the wafer chuck 15 are composed of fiber laminate. Moreover, a large number of cylindrical supporting pins 26 arranged in a peripheral area (second area) around the circle C are composed of SiC. In the second exemplary embodiment, the supporting pins 25a are composed of a fiber-reinforced material such as carbon fiber whose base material is fiber laminate. The fibers in the material extend in the vertical direction, and are laminated in the horizontal direction. The radius of the central area (circle C) is approximately half the radius of the wafer chuck 15. However, the radius of the central area can be set to approximately one third of that of the wafer chuck 15. The supporting pins 25a in the central area support the central portion of the wafer W, and the supporting pins 26 in the peripheral area support the peripheral portion of the wafer W.

The rigidity of the fiber laminate serving a base material of the fiber-reinforced material is low in the horizontal direction and high in the vertical direction. Therefore, when the supporting pins 25a are composed of the fiber-reinforced material, the supporting pins 25a deform in response to a force for returning the wafer W from the warped state to the original state. Thus, part of or all the strain in the wafer W can be released.

In the second exemplary embodiment, the supporting pins 25a composed of a fiber-reinforced material and having a low rigidity in the horizontal direction are arranged in the central area, and the supporting pins 26 composed of SiC and having a high rigidity in the horizontal direction are arranged in the peripheral area. Moreover, the supporting pins 25a arranged in the central area and the supporting pins 26 arranged in the peripheral area are both cylindrical. Furthermore, the ratios d/h of the supporting pins 25a and the supporting pins 26 are the same, and are larger than 0.35 times, for example, 1.00. However, the shapes and the ratios d/h of the supporting pins 25a and the supporting pins 26 can differ from each other. In addition, the supporting pins 25a composed of a fiber-reinforced material can be arranged in the entire area of the wafer chuck 15.

The substrate-retaining units according to the first and second exemplary embodiments attract and hold the wafer W with vacuum. However, the present invention can be applied to substrate-retaining units that attract and hold substrates such as wafers with electrostatic force. According to the first and second exemplary embodiments and the modifications thereof, part of or all the strain generated in the wafer W while the wafer W is attracted and held with vacuum can be released by the deformation of the supporting pins 25 or 25a, thereby the flatness of the wafer W can be corrected more reliably.

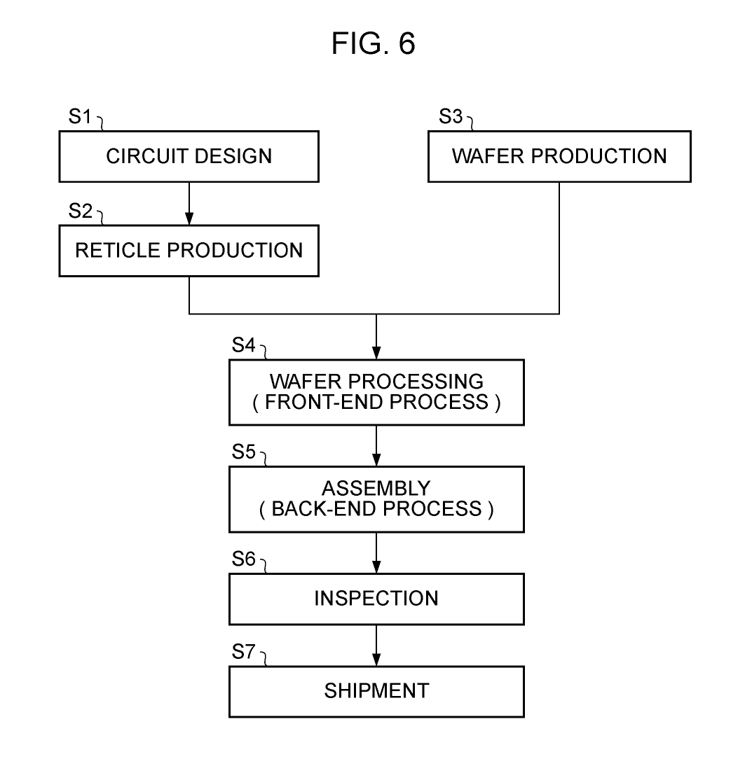

Next, an application of the present invention will be described. FIG. 6 is a flow chart of producing microscopic devices, for example, semiconductor chips such as ICs and LSI circuits, liquid-crystal panels, CCD sensors, thin-film magnetic heads, and micromachines. In Step S1 (circuit design), patterns of devices are designed. In Step S2 (reticle production), reticles R on which the designed patterns are formed are produced. On the other hand, wafers W are produced using materials such as silicon and glass in Step S3 (wafer production). Step S4 (wafer processing) is referred to as a front-end process in which circuits are formed on the wafers W by lithography technology using the reticles R and the wafers W.

Step S5 (assembly) is referred to as a back-end process in which semiconductor chips are produced using the wafers W processed in Step S4, and includes an assembly step (dicing and bonding), a packaging step (molding), and the like. In Step S6 (inspection), operations, durability, and the like of the semiconductor devices produced in Step S5 are checked. The semiconductor devices produced through these steps are then shipped (Step S7).

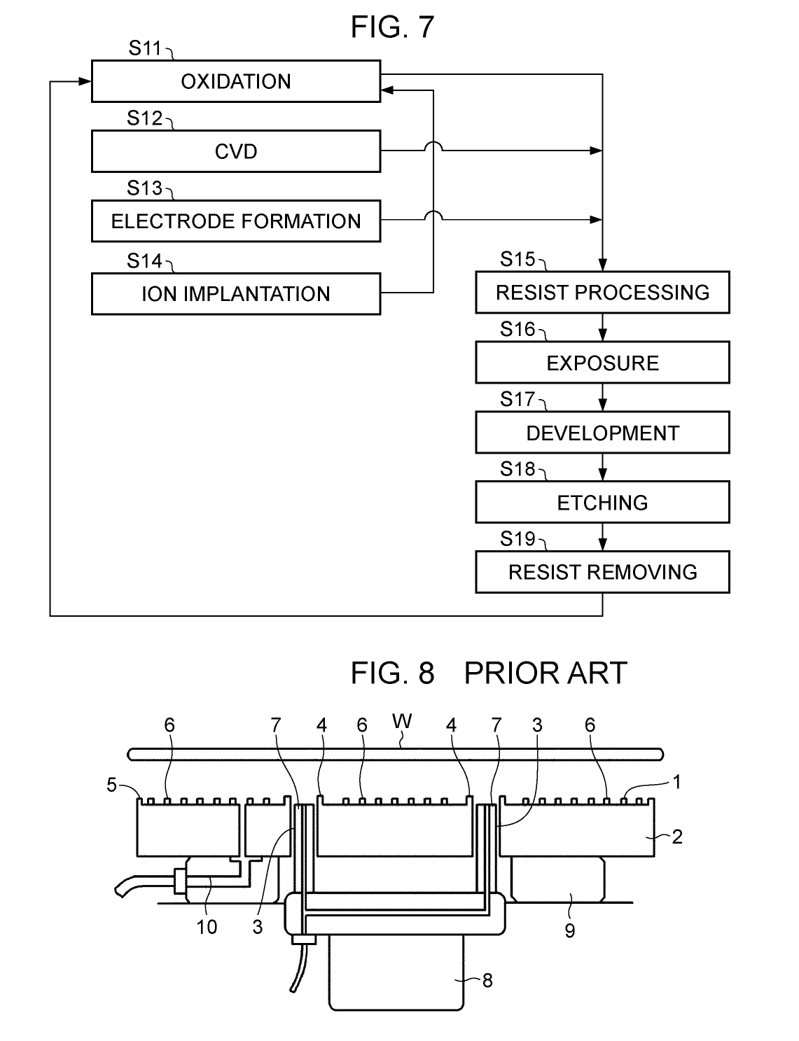

FIG. 7 is a flow chart illustrating the wafer processing in detail. In Step S11 (oxidation), the surfaces of the wafers W are oxidized. In Step S12 (chemical vapor deposition; CVD), insulating films are deposited on the surfaces of the wafers W. In Step S13 (electrode formation), electrodes are formed on the wafers W by vapor deposition. In Step S14 (ion implantation), ions are implanted in the wafers W. In Step S15 (resist processing), photosensitizer is applied to the wafers W. In Step S16 (exposure), the wafers W are exposed to light passing through the reticles R having circuit patterns using the reduced projection exposure apparatus described with reference to FIG. 1 according to an exemplary embodiment of the present invention. In Step S17 (development), the exposed wafers W are developed. In Step S18 (etching), portions other than those of the developed resist images are removed. In Step S19 (resist removing), the resist that is no longer required after etching is removed. Repetition of these steps can form multiplex circuit patterns on the wafers W.

With this production method, highly integrated devices can be stably produced.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the priority of Japanese Application No. 2006-254287 filed Sep. 20, 2006, which is hereby incorporated by reference herein in its entirety.

What is claimed is:

1. A substrate-retaining unit comprising:
a plurality of protrusions, a substrate being adhered to the unit while the substrate is supported by the protrusions,
wherein the rigidity of the protrusions in a horizontal direction is lower than the rigidity in a vertical direction at least in a central area of the unit.

2. The substrate-retaining unit according to claim 1, wherein the rigidity of the protrusions in the horizontal direction in a peripheral area of the central area is higher than the rigidity of the protrusions in the horizontal direction in the central area.

3. The substrate-retaining unit according to claim 1, further comprising:
vertically movable lift pins configured to support the substrate above the protrusions.

4. A substrate-retaining unit comprising:
a plurality of protrusions, a substrate being adhered to the unit while the substrate is supported by the protrusions,
wherein the protrusions arranged at least in a central area of the unit are composed of silicon carbide, and are cylindrical having a diameter d and a height h, the diameter d being less than or equal to 0.35 times the height h.

5. The substrate-retaining unit according to claim 4, wherein the protrusions arranged in a peripheral area of the central area are composed of silicon carbide, and are cylindrical having a diameter d larger than 0.35 times the height h.

6. The substrate-retaining unit according to claim 4, further comprising:
vertically movable lift pins configured to support the substrate above the protrusions.

7. A substrate-retaining unit comprising:
a plurality of protrusions, a substrate being adhered to the unit while the substrate is supported by the protrusions,
wherein the protrusions arranged at least in a central area of the unit are composed of fiber laminate.

8. The substrate-retaining unit according to claim 7, wherein the rigidity of the protrusions in the horizontal direction in a peripheral area of the central area is higher than the rigidity of the protrusions in the horizontal direction in the central area.

9. The substrate-retaining unit according to claim 8, wherein the protrusions arranged in the peripheral area of the central area are composed of silicon carbide, and are cylindrical having a diameter d and a height h, the diameter d being larger than 0.35 times the height h.

10. The substrate-retaining unit according to claim 7, further comprising:
vertically movable lift pins configured to support the substrate above the protrusions.

11. An exposure apparatus comprising:
an illumination optical system configured to illuminate an original;
the substrate-retaining unit according to claim 1 configured to hold a substrate to which photosensitizer is applied; and
a projection optical system configured to project light passing through the original onto the substrate.

12. An exposure apparatus comprising:
an illumination optical system configured to illuminate an original;
the substrate-retaining unit according to claim 4 configured to hold a substrate to which photosensitizer is applied; and
a projection optical system configured to project light passing through the original onto the substrate.

13. An exposure apparatus comprising:
an illumination optical system configured to illuminate an original;
the substrate-retaining unit according to claim 7 configured to hold a substrate to which photosensitizer is applied; and
a projection optical system configured to project light passing through the original onto the substrate.

14. A device manufacturing method, comprising:
applying photosensitizer to a wafer;
exposing the wafer to light using the exposure apparatus according to claim 11; and
developing the exposed substrate.

15. A device manufacturing method, comprising:
applying photosensitizer to a wafer;
exposing the wafer to light using the exposure apparatus according to claim 12; and
developing the exposed substrate.

16. A device manufacturing method, comprising:
applying photosensitizer to a wafer;
exposing the wafer to light using the exposure apparatus according to claim 13; and
developing the exposed substrate.
